(19) United States
(12) Patent Application Publication
(10) Pub. No.: US 2016/0117382 A1
(43) Pub. Date: Apr. 28, 2016

(54) DOCUMENT TOPIC IDENTIFICATION

(71) Applicant: HEWLETT-PACKARD DEVELOPMENT COMPANY, L.P., Houston, TX (US)

(72) Inventors: Alexander Ulanov, Saint-Petersburg (RU); Alexander Sidorov, Saint-Petersburg (RU)

(21) Appl. No.: 14/897,320

(22) PCT Filed: Jun. 19, 2013
(86) PCT No.: PCT/RU2013/000520

§ 371 Date: Dec. 10, 2015

(51) Int. Cl. G06F 17/30; G06K 9/00

(52) U.S. Cl. CPC G06F 17/30598; G06K 9/00469; G06K 9/00483; G06K 9/00456; G06F 17/30011

(57) ABSTRACT

Topics for a document are identified using names of categories in a knowledge base. Terms are extracted from document text. The extracted terms are mapped to articles in the knowledge base. The number of terms that are mapped to each article are counted. The number of articles to which the terms are mapped are also counted for each category. The categories that include the articles having the mapped terms are sorted such that the most relevant categories for the document correspond to the categories that include the highest number of articles to which the terms are mapped. The most relevant categories are then identified as the topics for the document.

### BACKGROUND

A wide variety of documents are available on the Internet. The large number of documents accessible online makes the organization of such documents imperative so that a user may search for and locate desired information. One way to organize documents is by topic. Determining a topic under which a document may be categorized assists a user in identifying the relevancy of the document to the user's needs.

### BRIEF DESCRIPTION OF THE DRAWINGS

The following detailed description references the drawings, wherein:

FIG. 1 is a block diagram of an example server computing device in communication via a network with a client computing device for identifying document topics; and

FIG. 2 is a flowchart of an example method for execution by a client computing device and a server computing device for identifying document topics.

### DETAILED DESCRIPTION

The task of finding relevant topics for a document is useful for many applications such as news article classification and document retrieval. Topics may be identified using a training set of labeled documents and predefined topics or classes. However; this approach may become laborious when the number of topics approaches tens of thousands. Another problem arises since a training set is difficult to create for a large number of topics. Knowledge bases may be used in the absence of training sets for finding relevant document topics. An example knowledge base includes Wikipedia.

Wikipedia is an online encyclopedia including articles written and provided by a number of different contributors. Each page in the Wikipedia knowledge base may include an article describing a particular concept or a category representing a topic. The contributor may identify specific categories for the article when the article is provided to Wikipedia. Each article or category may have a title and a section of parent categories. Each article may also include text and hyperlinks to other articles. Each category may include lists of subcategories (i.e., child categories) and articles. Each category may also be included in a broader category (i.e., a parent category).

Wikipedia pages may be used to identify relevant topics for a document. In some approaches, individual words in a document may be mapped to Wikipedia pages. The words may then be ranked according to their importance in the document and in Wikipedia. The words may then be used as relevant topics or additional topics may be found by propagating to other concepts via Wikipedia links. Other approaches may employ measuring text similarity between a given document and Wikipedia articles. The most similar articles may be used as relevant topics. However, due to the large number of articles in Wikipedia, these approaches cannot categorize individual documents in a timely manner.

Example embodiments disclosed herein address these issues by identifying document topics using names of categories in a knowledge base. A document to be classified is received. Terms are extracted from the text of the document. The extracted terms are mapped to articles in a knowledge base. The number of terms that are mapped to each article is counted. The number of articles to which the terms are mapped is also counted for each category. The categories that include the articles having the mapped terms are then sorted such that the most relevant categories for the document correspond to the categories that include the highest number of articles to which the terms are mapped. The most relevant categories are then identified as the topics for the document.

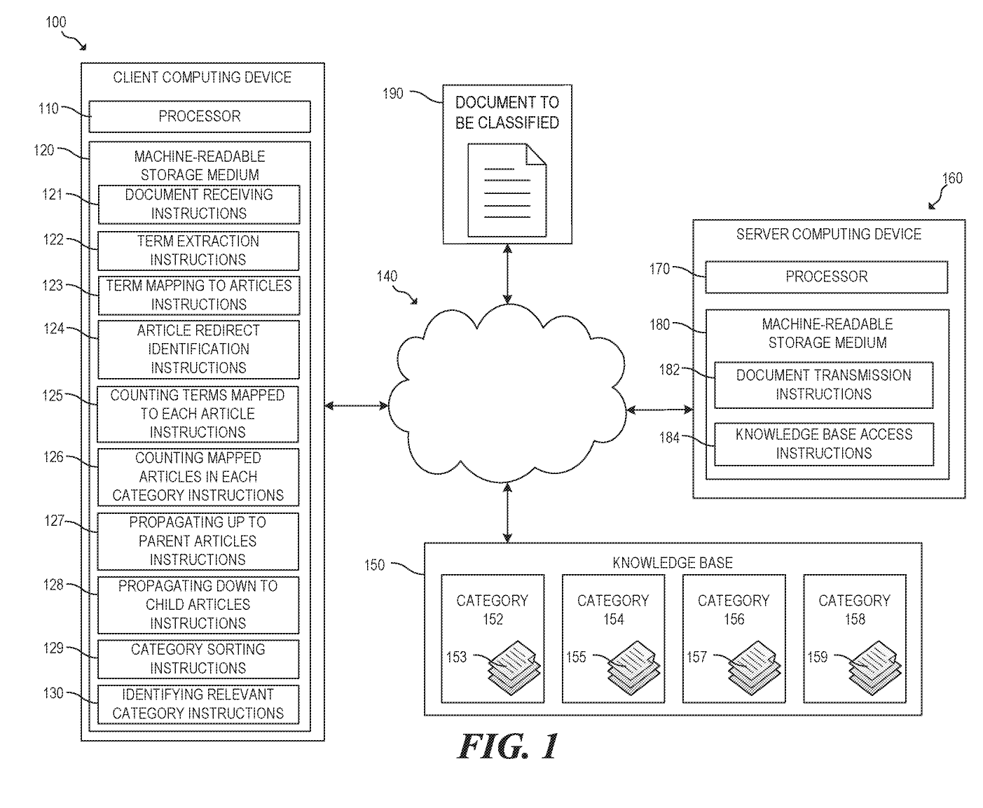

Referring now to the drawings, FIG. 1 is a block diagram of an example server computing device 160 in communication via a network 140 with a client computing device 100. As illustrated in FIG. 1 and described below, server computing device 160 may communicate with client computing device 100 and a knowledge base 150 to provide data for client computing device 100 to identify document topics. Knowledge base 150 may be accessible through network 140 at a uniform resource locator (URL). In some embodiments, knowledge base 150 may be a web site that hosts wiki pages. An example of knowledge base 150 may be the Wikipedia web site. Knowledge base 150 may include a variety of different articles 153, 155, 157, 159 each of which may be assigned to one or more categories 152, 154, 156, 158. Even though only four categories are illustrated in FIG. 1, knowledge base 150 may include a large number of different categories under which articles may be classified.

Server computing device 160 may be any computing device accessible to a client device, such as client computing device 100, over network 140. Example networks include the Internet, a local area network (LAN), and a wide area network (WAN). In the embodiment of FIG. 1, server computing device 160 includes a processor 170 and a machine-readable storage medium 180.

Processor 170 may be one or more central processing units (CPUs), microprocessors, and/or other hardware devices suitable for retrieval and execution of instructions stored in machine-readable storage medium 180. Processor 170 may fetch, decode, and execute instructions 182, 184 to provide client computing device 100 with data for identifying document topics, as described below. As an alternative or in addition to retrieving and executing instructions, processor 170 may include one or more electronic circuits comprising a number of electronic components for performing the functionality of one or more of instructions 182, 184.

Machine-readable storage medium 180 may be any electronic, magnetic, optical, or other physical storage device that stores executable instructions. Thus, machine-readable storage medium 180 may be, for example, Random Access Memory (RAM), an Electrically-Erasable Programmable Read-Only Memory (EEPROM), a storage drive, an optical disc, and the like. As described in detail below, machine-readable storage medium 180 may be encoded with executable instructions 182, 184 for providing data to client computing device 100 for identifying document topics.

Client computing device 100 may be, for example, a notebook computer, a desktop computer, an all-in-one system, a thin client, a workstation, a tablet computing device, a mobile phone, or any other computing device suitable for execution of the functionality described below. In FIG. 1, client computing device 100 includes processor 110 and machine-readable storage medium 120.

As with processor 170 of server computing device 160, processor 110 may be one or more CPUs, microprocessors, and/or other hardware devices suitable for retrieval and execution of instructions 121, 122, 123, 124, 125, 126, 128, 129, 130. Processor 110 may fetch, decode, and execute instructions to identify document topics. Processor 110 may also or instead include electronic circuitry for performing the functionality of one or more instructions 121-130. As with storage medium 180 of server computing device 160, machine-readable storage medium 120 may be any physical storage device that stores executable instructions.

Communication may be established between client computing device 100 and server computing device 160. For example, client computing device 100 may access server computing device 160 at a predetermined Uniform Resource Locator (URL) and, in response, server computing device 160 may establish a communication session with client computing device 100. In some implementations, client login credentials, such as a user identifier and a corresponding authentication parameter (e.g., a password), may be used to establish communication with server computing device 160.

A document to be classified 190 may be uploaded to network 140. Document to be classified 190 may be any type of document for which relevant topics may be identified. For example, document 190 may be an article hosted on a web site or submitted by a user. Document to be classified 190 may include text.

Document receiving instructions 121 may receive document to be classified 190 from network 140. A user of client computing device 100 may request document 190 from a specific uniform resource locator (URL) such that document transmission instructions 182 of server computing device 160 may cause document 190 to be forwarded to client computing device 100. Topics for document 190 may not yet be identified when document 190 is received at client computing device 100.

Term extraction instructions 122 may extract terms from document 190. The terms that are extracted may include text fragments. For example, the terms that are extracted from document 190 may be noun phrases. The terms that are extracted may contribute to the topics that are discussed in document 190. An example of an extracted term may be “machine learning”.

Term mapping to articles instructions 123 may map the extracted terms to articles in knowledge base 150. Client computing device 100 may forward the extracted terms to knowledge base access instructions 184 of server computing device 160. Knowledge base access instructions 184 may access knowledge base 150 to identify which articles 153, 155, 157, 159 include the extracted terms. Each article that includes any of the extracted terms may be identified in knowledge base 150. For example, articles that include the term “machine learning” may be identified.

Article redirect identification instructions 124 may identify whether an article that includes an extracted term is a redirect. A redirect refers to an article to which an initial article is redirected to provide additional information about a concept. An article may be redirected to avoid having to include the same information on different pages. In the event that the article is a redirect, article redirect identification instructions 124 may cause the article to be replaced with the redirected article.

Counting terms mapped to each article instructions 125 may count the number of extracted terms mapped to each article. For example, one article may include many of the same terms that were extracted from the document. In some cases, the article may include more than one instance of the same term. For example, an article may include ten instances of the term “machine learning”. Each instance of each extracted term may be counted.

Counting mapped articles in each category instructions 126 may count the number of mapped articles in each category. For example, a category titled “computer science” may have over one hundred different articles in the category where each of the articles includes terms extracted from the document. Each article that includes an extracted term and is included in a same category is counted, and the count is associated with the category as a category score.

Propagating up to parent category instructions 127 may be used to expand the number of categories to include parent categories associated with the categories that include the mapped articles. For example, a parent category for a category named “computer science” may be “mathematics”. The mapped articles that are included in the parent category may also be counted to identify topics for the document. Specifically, the category score for each category may be assigned to the corresponding parent category and this parent category may be considered as a topic for the document.

Propagating down to child category instructions 128 may identify additional categories for the document. For the “computer science” category, an example child category may be “computer language”. The mapped articles that are included in the child category may also be counted to identify topics for the document. Specifically, the category score for a category may be assigned to any corresponding child categories. These child categories may be considered as topics for the document.

Category sorting instructions 129 may sort the categories (and any parent categories and child categories) to which the mapped articles are mapped. The categories may be sorted in descending order from the categories that have the most articles mapped thereto to the categories that have the least number of articles mapped thereto.

Identifying most relevant category instructions 130 may identify the categories that have the most articles mapped thereto as the most relevant categories. A threshold may be set such that a category is identified as relevant when the number of articles mapped to the category is above the threshold. For example, a threshold may be set at one hundred. In this case, a category that includes more than one hundred mapped articles may be identified as a topic for the document. The categories that include a number of articles that are above the threshold are then identified as topics for the document.

Document topic identification may be implemented as an algorithm as illustrated below,

```
Input: input text (text)
Output: list of topics sorted by score (topics)
  1: termList ← getTerms(text)
  2: articles ← matchTermsToArticlePages(termList)
  3: for term: termList do
  4: for c: getCategories(articles[term]) do
  5: S_{c}⁰ ← S_{c}⁰ + count(text, term)
  6: end for
  7: end for
  8: r₀ = 0
  9: for k = 1 → (propagationsNumber) do
10: ${S}_{i}^{k} ← {\sum }_{j : {c}_{j} \to {c}_{k}} {S}_{j}^{k - 1} \cdot {r}_{k}$
11: rₖ ← r · rₖ₋₁
12: end for
13: topics = topScoredCategories(S^{propagationsNumber})
```

A document to be classified may be received as input and a list of topics identified for the document may be provided as output.

Referring to line 1 of the algorithm, terms may be extracted from the document to be classified and provided in a term list. In some implementations, the terms that are extracted from the document are noun phrases. The noun phrases may be extracted using a speech tagger and a pattern for any sequence of nouns.

Referring to line 2 of the algorithm, the terms in the term list may be mapped to articles in a knowledge base. The mapped articles include at least one term in the term list.

Referring to lines 3-7 of the algorithm, for each article to which terms are mapped, the number of terms that are mapped to the article are counted. In some implementations, each instance of a term in an article may be counted separately. Then, a score for each category of each article is determined. The category score is the sum of mapped article counts in the same category.

Referring to lines 9-12, several iterations of propagation may be run for the obtained score. Propagation may be performed upward from the categories to parent categories. Parent categories refer to categories that are more broadly construed than the categories such that more than one of the categories may be included in one parent category. Propagation may also be performed downward from the categories to child categories. Child categories refer to categories that are more narrowly construed than the categories such that more than one of the child categories may be included in one category.

Propagation begins from the categories that include articles containing mapped terms from the document. When propagating upward, the scores of the categories are propagated to the parent categories. When propagating downward, the scores of the categories are propagated to the child categories. The number of iterations in either direction and a coefficient are algorithm parameters. The number of iterations is provided in the algorithm as “propagationsNumber”, and the coefficient is provided in the algorithm as “r”. For example, the number of iterations and the coefficient may be set to a value to propagate upward from a category to a parent category and then to a grandparent category. In another example, the number of iterations and the coefficient may be set to propagate downward from a category to a child category and then to a grandchild category. Any propagated categories that receive a category score during the propagation may be considered as topics for the document.

Referring to line 13, after propagation, all categories are sorted by score in decreasing order. Then, the categories that have a score above a predetermined threshold may be provided as topics for the document.

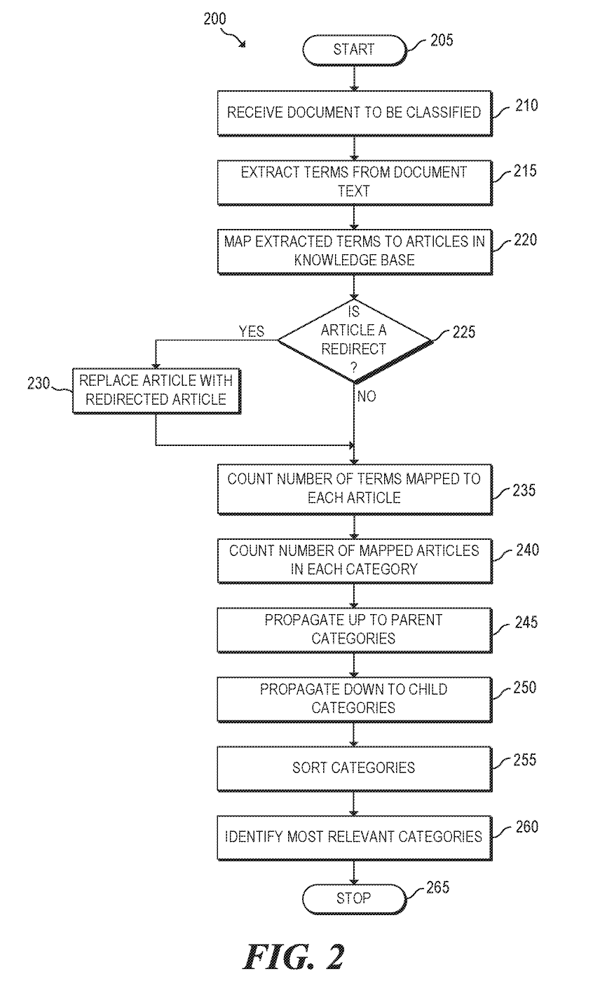

FIG. 2 is a flowchart of an example method 200 for execution by client computing device 100 and server computing device 160 for identifying topics for a document to be classified. Although execution of method 200 is described below with reference to client computing device 100 and server computing device 160 of FIG. 1, other suitable devices for execution of method 200 will be apparent to those of skill in the art. Method 200 may be implemented in the form of executable instructions stored on a machine-readable storage medium, such as storage mediums 120, 180, and/or in the form of electronic circuitry.

Method 200 may start in block 205 and continue to block 210, where a document to be classified is received. The document may be received from a variety of different sources. For example, a user may generate a document to be classified at client computing device 100. In other examples, the document to be classified may be downloaded from a web site using server computing device 160. The document to be classified may be any type of document for which a user would like to identify topics discussed in the document. For example, the document may be a news article.

Next, in block 215, terms are extracted from the text of the document. The terms that are extracted may contribute to the identification of topics for the document. In some implementations, the terms that are extracted from the document include noun phrases.

In block 220, the extracted terms may be mapped to articles in a knowledge base. The mapped articles may include some of the terms extracted from the document. Accordingly, the mapped articles may be related to the document since these articles include some of the same terms as the document. An example of a knowledge base may be Wikipedia.

The knowledge base may be a collection of articles that are organized by category. In a knowledge base such as Wikipedia, article contributors may assign different categories to the article when the contributor provides the article to the knowledge base. One article may be associated with multiple categories. Each category may be associated with a parent category and a child category, and may also be associated with a grandparent category and a grandchild category. The parent category may be defined more broadly than a child category such that a number different child categories is included in the same parent category. For example, a category may be “machine learning”, The “machine learning” category may have a parent category of “artificial intelligence” and a child category of “optical character recognition”. In addition, “optical character recognition” may be a grandchild category of the “artificial intelligence” category, and “artificial intelligence” may be a grandparent category of the “optical character recognition” category.

Next, in block 225, a determination is made as to whether the article is a redirect. A redirect refers to an article to which a different article refers to so that a user may access the redirected article to obtain additional information for a concept. Redirects are useful to avoid having to include the same information in different articles of the knowledge base. In the event that the article is a redirect, processing proceeds to block 230 where the article is replaced with the redirected article; otherwise, processing moves to block 235.

Next, in block 235, a number of terms mapped to each article is counted. In the case where a large number of extracted terms are mapped to an article, there is a strong likelihood that the document and the article are related to the same or similar topics. Likewise, if a relatively low number of extracted terms are mapped to an article, then the document and the article probably do not discuss many of the same topics. Each term may be included more than once in a particular article. In this case, the term may be counted each time the term appears in the article.

Next, in block 240, the number of articles in each category is counted, and the total number of articles in each category is provided as a category score for the category. For example, in a category named “transistors” there may be three hundred twenty articles that include terms extracted from the document. Accordingly, the “transistors” category is assigned a score of three hundred twenty.

Next, in block 245, the parent categories of each category that includes an article having terms mapped thereto may be used to encompass additional categories for the document. For example, for the “transistors” category, a parent category may be “electronics” which includes articles about other types of electronic elements in addition to transistors. The parent categories may be used as additional categories for identifying document topics. Specifically, the category score for each category may be assigned to the corresponding parent category and this parent category may be considered as a topic for the document. For example, the “electronics” parent category may be assigned the category score of three hundred twenty from the “transistors” category. The “electronics” category may also be assigned additional scores from other categories of electronic elements. The number of levels of parent categories that may be used to encompass additional categories for the document is an algorithm parameter that may be adjusted based on user selection.

Next, in block 250, the child categories of each category that includes a mapped article may be used to encompass additional categories for the document. For example, for the “transistors” category, a child category may be “bipolar junction transistors” which includes articles about transistors that operate using two different types of semiconductor material. Specifically, the category score for each category may be assigned to a corresponding child category and this child category may be considered as a topic for the document. For example, the “bipolar junction transistors” child category may be assigned the category score of three hundred twenty from the “transistors” category. The number of levels of child categories that may be used to encompass additional categories for the document is an algorithm parameter that may be adjusted based on user selection.

Next, in block 255, the categories may be sorted based on the number of mapped articles in each category that include the terms extracted from the document. For example, the category “electronics” may include over five hundred articles that include extracted terms, the category “transistors” may include over three hundred articles that include terms extracted from the document, and the category “bipolar junction transistors” may include less than ten articles having the extracted terms.

Finally, in block 260, the most relevant categories may be identified and assigned to the document. The most relevant categories may be identified using a threshold. For example, a threshold may be set at two hundred articles such that a category that has more than two hundred articles with the extracted terms is identified as a topic for the document. The categories that are identified are then assigned to the document as topics. The assigned topics may be used for categorization and subsequent retrieval of the document. Method 200 may subsequently proceed to block 265, where method 200 may stop.

The foregoing disclosure describes a number of examples for identifying document topics. In this manner, the examples disclosed herein enable a document to be assigned topics based on categories of articles provided in a knowledge base. The topics may be used to categorize the document for subsequent retrieval.

We claim:

1. A method of identifying document topics, the method comprising:
receiving a document at a client computing device;
extracting terms from the document using a processor;
mapping the extracted terms to articles using the processor; wherein the articles are stored in a knowledge base; each article being associated with a category in the knowledge base;
counting a number of the terms that are mapped to each article using the processor;
counting a number of the mapped articles in each category using the processor; and
identifying a category for the document as a topic, wherein the identified category is the category that includes the highest number of mapped articles.

2. The method of claim 1, wherein counting a number of the terms that are mapped to each article comprises counting multiple instances of a same term individually.

3. The method of claim 1, further comprising:
identifying one of the articles as being redirected to a different article,
wherein the extracted terms are mapped to the different article.

4. The method of claim 1, wherein the knowledge base is accessed at a web site.

5. The method of claim 4, wherein the web site is a wiki page.

6. The method of claim 1, wherein the terms are noun phrases.

7. A machine-readable storage medium encoded with instructions executable by a processor of a computing device for identifying document topics, the machine-readable storage medium comprising:
instructions for receiving a document,
instructions for extracting terms from the document using a processor,
instructions for mapping the extracted terms to articles using the processor, wherein the articles are stored in a knowledge base, each article being associated with a category in the knowledge base,
instructions for counting a number of the terms that are mapped to each article using the processor,
instructions for counting a number of the mapped articles in each category using the processor, and
instructions for identifying a plurality of categories for the document as topics, wherein the identified plurality of categories comprises the categories having a number of mapped articles that is greater than a threshold.

8. The machine-readable storage medium of claim 7, further comprising:
instructions for identifying a parent category of each of the identified plurality of categories,
instructions for propagating each of the plurality of categories to the corresponding parent category such that the number of mapped articles in each category of the plurality of categories is assigned to the corresponding parent category, and
instructions for identifying a parent category for the document, wherein the identified parent category is the parent category having the highest number of mapped articles.

9. The machine-readable storage medium of claim 7, further comprising:
instructions for identifying a child category of each of the identified plurality of categories,
instructions for propagating each of the plurality of categories to the corresponding child category such that the number of mapped articles in each category of the plurality of categories is assigned to the corresponding child category, and
instructions for identifying a child category for the document, wherein the identified child category is the child category having the highest number of mapped articles.

10. The machine-readable storage medium of claim 7, wherein the instructions for counting a number of the terms that are mapped to each article counts multiple instances of a same term individually.

11. The machine-readable storage medium of claim 7, further comprising:
instructions for identifying one of the articles as being redirected to a different article,
wherein the extracted terms are mapped to the different article.

12. The machine-readable storage medium of claim 7, wherein the knowledge base is accessed at a web site.

13. A computing device for identifying document topics, the client computing device comprising:
a processor to:
extract terms from a document;
map the extracted terms to articles, wherein the articles are stored in a knowledge base, each article being associated with a category in the knowledge base;
count a number of the terms that are mapped to each article;
count a number of the mapped articles in each category; and
identify a plurality of categories for the document as topics, wherein the identified plurality of categories is the categories having a number of mapped articles that is greater than a threshold.

14. The computing device of claim 10, wherein the processor further acts to:
identify a parent category of each of the identified plurality of categories,
propagate each of the plurality of categories to the corresponding parent category such that the number of mapped articles in each category of the plurality of categories is assigned to the corresponding parent category, and
identify a plurality of parent categories for the document, wherein the identified plurality of parent categories are the parent categories that have a number of mapped articles that exceed a threshold.

15. The computing device of claim 10, wherein the processor further acts to:
identify a child category of each of the identified plurality of categories,
propagate each of the plurality of categories to the corresponding child category such that the number of mapped articles in each category of the plurality of categories is assigned to the corresponding child category, and
identify a plurality of child categories for the document, wherein the identified plurality of child categories are the child categories that have a number of mapped articles that exceed a threshold.
